(19) United States
(12) Patent Application Publication
(10) Pub. No.: US 2014/0032506 A1
(43) Pub. Date: Jan. 30, 2014

(54) SYSTEM AND METHODS FOR REAL-TIME DETECTION, CORRECTION, AND TRANSFORMATION OF TIME SERIES DATA

(71) Applicant: Quality Attributes Software, Inc., Bayville, NJ (US)

(72) Inventors: Bill Hoey, Bayville, NJ (US); Nasser Dassi, New Berlin, WI (US)

(21) Appl. No.: 13/916,513

(22) Filed: Jun. 12, 2013

Related U.S. Application Data
(60) Provisional application No. 61/658,873, filed on Jun. 12, 2012.

(51) Int. Cl. G06F 17/30

(52) U.S. Cl. CPC G06F 17/30303
USPC 707/691

(57) ABSTRACT

Systems and methods for time series data error detection, correction, and transformation may detect gaps and anomalies in time series data, such as from a meter device, and may correct the gaps and adjust the anomalies prior to long-term record storage. Data forecasting may be used to correct the errors in the time series data. The error corrected data may be regarded as an actual set of time series data and become a base data set against which additional heuristic projections are generated. In addition, the time series data may be transformed into any number of physical and virtual device hierarchies that represent the underlying data source configurations, and may then be stored in an analytical database for further analysis. The hierarchies may be irregular and may change over time.

### CROSS-REFERENCES TO RELATED APPLICATIONS

This application claims the benefit of U.S. Provisional Patent Application No. 61/658,873, filed Jun. 12, 2012, entitled SYSTEM AND METHODS FOR REAL TIME ERROR CORRECTION AND PROJECTION MODELING OF ENERGY TIME SERIES DATA, and incorporates its disclosure by reference.

### BACKGROUND OF THE INVENTION

Detection and correction of errors in time series data, such as from a meter device, are traditionally performed after the time series data has already been stored in a long term data storage warehouse. This requires repeated and computationally expensive on-demand calculations to detect and correct errors whenever a report, analysis, or visual representation is desired. In addition, representing hierarchies of time series data, such as from a hierarchy of meter devices, traditionally requires a “regular” or normalized hierarchy structure, where each branch of the hierarchy comprises the same level of depth. This fails to take into account that different branches of a hierarchy may reflect varying degrees of metering complexity. These factors inhibit a real-time, accurate, and comprehensive analysis of time series data, and limit the ability to view the various time series data sets from different perspectives.

### SUMMARY OF THE INVENTION

Systems and methods for time series data error detection, correction, and transformation may detect gaps and anomalies in time series data, such as from a meter device, and may correct the gaps and adjust the anomalies prior to long-term record storage. Data forecasting may be used to correct the errors in the time series data. The error corrected data may be regarded as an actual set of time series data and become a base data set against which additional heuristic projections are generated. In addition, the time series data may be transformed into any number of physical and virtual device hierarchies that represent the underlying data source configurations, and may then be stored in an analytical database for further analysis. The hierarchies may be irregular and may change over time.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 representatively illustrates a system for error detection, correction, and transformation according to various aspects of the present invention;

FIG. 2 representatively illustrates a hypothetical entity hierarchy; and

FIG. 3 representatively illustrates a method for error detection, correction, and transformation according to various aspects of the present invention.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of hardware or software components configured to perform the specified functions and achieve the various results. For example, the present invention may employ systems, technologies, algorithms, designs, and the like, which may carry out a variety of functions. In addition, the present invention may be practiced in conjunction with any number of hardware and software applications and environments, and the system described is merely one exemplary application for the invention. Software and/or software elements according to various aspects of the present invention may be implemented with any software language or standard, such as, for example, MultiDimensional eXpressions language (MDX), AJAX, C, C++, Java, COBOL, assembly, PERL, eXtensible Markup Language (XML), PHP, etc., or any other programming, scripting, query, or other software language or standard, whether now known or later developed.

The present invention may also involve multiple programs, functions, computers and/or servers. While the exemplary embodiments are described in conjunction with conventional computers, the various elements and processes may be implemented in hardware, software, or a combination of hardware, software, and other systems. Further, the present invention may employ any number of conventional techniques for providing systems and methods for real time error detection, correction, and/or transformation of time series data.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

Systems and methods for error detection and correction of time-series data according to various aspects of the present invention may operate in conjunction with any suitable computing process or machine, interactive system, telecommunication network, meter device, building, and/or building monitoring environment. Various representative implementations of the present invention may be applied to any system and method for real-time time series error detection, correction, and/or transformation, which may detect gaps and anomalies in time series data and apply algorithms to correct gaps and adjust anomalies prior to long-term record storage, such as in a data warehouse and/or an analytical database, and may transform time series data to facilitate further analysis.

Various representative algorithms may be implemented with any combination of data structures, objects, processes, routines, other programming elements, and computing components and/or devices. Further, the present invention may employ any number of conventional techniques for data transmission, signaling, data processing, network control, and/or the like. Applications according to various aspects of the present invention may be formulated and a network may be provided that may include any system for exchanging data, such as, for example, a telecommunication network such as the Internet, an intranet, an extranet, WAN, LAN, satellite communications, and/or the like. The network may be implemented as other types of networks, such as an interactive television (ITV) network. The users may interact with the system by any input device such as a keyboard, mouse, kiosk, personal digital assistant, handheld computer, cellular phone such as a Smartphone that may have access to the internet, text messaging by cellular phone and/or the like. Similarly, the invention may be used in conjunction with any type of personal computer, network computer, workstation, minicomputer, mainframe, or the like running any operation system such as any version of Windows, Windows XP, Windows ME, Windows Mobile, Windows NT, Windows 2000, Windows Server, Windows 98, Windows 95, Windows Vista, Windows 7, Mac OS X, OS/2, BeOS, Linux, UNIX, or any other operating system, whether now known or hereafter. Moreover, the invention may be implemented with TCP/IP communications, IPX, AppleTalk, IP-6, NetBIOS, OSI or any number of existing or future protocols. Moreover, the system may comprise the use, sale and/or distribution of all goods, services and/or information having similar functionality described herein. The various computing devices described herein may be referred to as computing units.

A computing unit may comprise conventional components, such as a processor, a local memory such as RAM, long term memory such as a hard disk, a network interface, and any number of input and/or output peripherals such as a keyboard, mouse, monitor, touch screen, and the like. The various memories of the computing unit may facilitate the storage of one or more computer instructions, such as a software routine and/or software program, which may be executable by the processor to perform the methods of the invention. Further, for security reasons, any databases, systems, and/or components of the present invention may consist of any combination of databases or components at a single location or at multiple locations, wherein each database or system includes any of various suitable security features, such as firewalls, access codes, encryption, de-encryption, compression, decompression, and/or the like.

The computing units may be connected with each other by a telecommunication network. The telecommunication network may comprise a collection of terminal nodes, links, and any intermediate nodes which are connected to enable communication at a distance between the terminal nodes. A telecommunication network may be simply referred to as a network. In some embodiments, a terminal node may comprise a computing unit. The network may be a public network and assumed to be insecure and open to eavesdroppers. The network may also be a private network and assumed to be secure and closed to eavesdroppers. In one exemplary implementation, the network may be embodied as the Internet. In this context, computers may or may not be connected to the Internet at all times.

Telecommunication may be accomplished through any suitable communication system, such as, for example, a telephone network, intranet, Internet, point of interaction device (point of sale device, personal digital assistant, cellular phone, kiosk, etc.), online communications, off-line communications, wireless communications, a radio dispatch network, and/or the like.

A variety of conventional communications media and protocols may be used for the communication links, such as, for example, a connection to an Internet Service Provider (ISP) over the local loop as is typically used in connection with standard modem communication, wireless cellular communication, cable modem, Dish networks, ISDN, Digital Subscriber Line (DSL), and/or various wireless communication methods. Polymorph code systems might also reside within a local area network (LAN) which interfaces to a network through a leased line (T1, T3, etc.). A communicative link may comprise any form or method for communication, such as a computer network, communication between software routines, and the like. A communicative link may comprise any intermediary device, system, method, and the like, between the two items so linked.

The present invention may be embodied as a method, a system, a device, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code embodied in the storage medium. Any suitable computer-readable storage medium may be utilized, including hard disks, CD-ROM, optical storage devices, magnetic storage devices, and/or USB memory keys and the like.

A real-time time series data error detection, correction, and transformation system and method may detect gaps and anomalies in time series data and apply heuristic algorithms to correct the gaps and adjust the anomalies prior to long-term record storage, such as in a data warehouse and/or an analytical database. A real-time time series data error detection, correction, and transformation system and method may transform the time series data into any number of hierarchies representing any number of configurations of physical and/or virtual meter devices.

Time series data may comprise a sequence of time series data points and may correspond to meter readings. The error detection, correction, and transformation systems and methods may analyze time series data and may generate heuristic projections, also referred to as data forecasts, based on a set of time series data and possibly a variable set of influencing factors. The error detection, correction, and transformation systems and methods, including the data forecasting systems and methods, may be implemented on or by computer systems that are responsible for obtaining, distributing, and/or storing more than a single time series data point at a time. Time series data may be corrected based on the data forecasts, and the error corrected data may be regarded as an actual set of time series data and become the base data set against which, when possibly combined with influencing factors, additional heuristic projections may be generated. The resultant time series data may be subject to additional analysis by the aforementioned error detection and correction system and method.

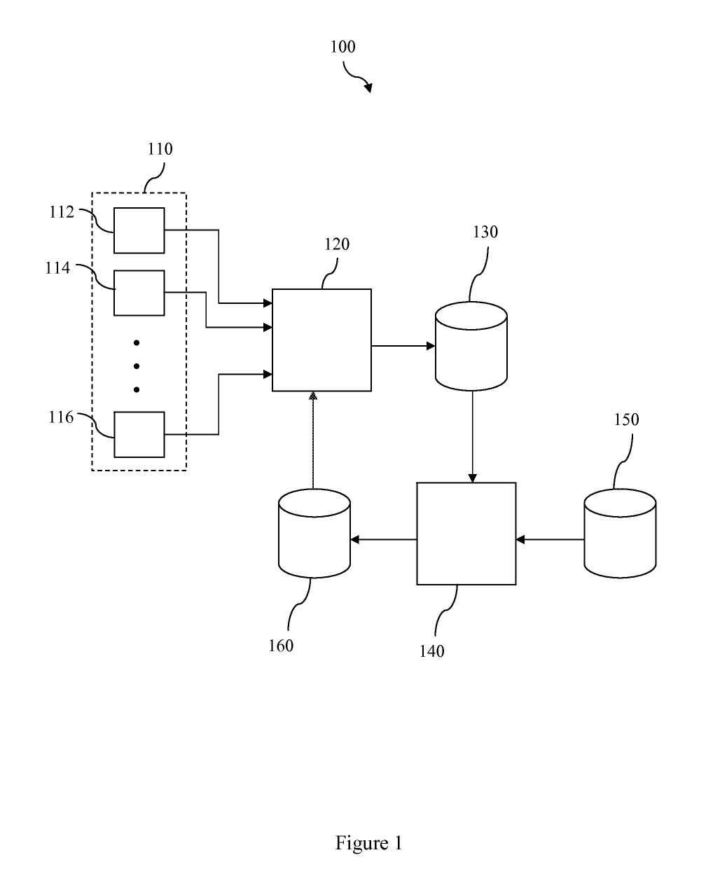

Referring to FIG. 1, a time series data error detection, correction, and transformation system 100 according to the present invention may comprise an error detection and correction (“EDC”) module 120, a data warehouse 130, a transformation module 140, a configuration definition store 150, and an analytical database 160. The EDC module 120 may be configured to receive time series data (whether a single time series data point or multiple data points) representing data from one or more meter devices 112, 114, 116. The meter devices 112, 114, 116 may be referred to as one or more meter devices 110, meter devices 110, the meter devices 110, the meter device 110, or a meter device 110.

The time series error detection, correction, and transformation system 100 may be configured to operate in conjunction with any number and type of meter devices 110. For example, the time series error detection, correction, and transformation system 100 may be configured to receive time series data corresponding to any number of meter devices 110. Time series data from a meter device 110, whether a single data point or multiple data points, may be referred to as a meter reading. The meter devices 110 may comprise physical (actual) meter devices. The meter devices 110 may comprise virtual meter devices that are not physical meter devices, but represent an alternate manifestation of one or more underlying physical meter devices (e.g. Virtual Meter Device 1 is Physical Meter Device 1 times 5, Virtual Meter Device 2 is Physical Meter Device 1 divided by Pi, Virtual Meter Device 3 is Virtual Meter Device 2 plus Physical Meter Device 2). Consequently, the meter devices 110 may comprise any combination of physical meter devices and virtual meter devices, and a meter reading may correspond to a physical or virtual meter device. Further, time series data received from the meter device 110, whether physical or virtual, and before undergoing further error detection, error correction, or transformation, may be referred to as “raw.”

The meter devices 110 may comprise any device or representation of a device configured to detect, measure, or otherwise receive and/or transmit information. For example, the meter devices 110 may comprise any suitable system for detecting or measuring a physical quantity. A meter device 110 may comprise a utility meter, sub-meter, sensor, or any device directly or indirectly capable of providing information about a facility. For example, a meter devices 110 may indirectly provide information through a building management system (“BMS”), a lighting control system, or any other form of building automation system. For further example, the meter devices 110 may comprise a BMS, a lighting control system, or any other form of building automation system. In some cases, data received corresponding to a meter device 110 may not originate from values observed by the meter device 110, but may instead be manually input to represent the readings of the meter device 110.

In an exemplary embodiment, the meter device 110 may detect and/or collect information corresponding to utility consumption and may communicate the same or related information via a network. Utility consumption may comprise the use of one or more utilities and/or power sources. For example, utility consumption may comprise the use of water, electricity, natural and/or other gas, and may comprise the use of other sources that provide heating, cooling, electricity, water, lighting, and the like to a facility, such as a building. Further, utility consumption may comprise the use of gasoline and/or other energy sources used to power equipment, such as lawn mowers, backup generators, vehicles, or other transportation.

Additionally, utility consumption may comprise the generation of one or more utilities and/or generation of power. For example, a building may generate electricity through the use of solar panels. Information corresponding to the generated electricity may be appropriately measured and transmitted by one or more meter devices 110. In some embodiments, the meter device 110 may comprise a sensor configured to detect and/or measure one or more environmental conditions. An environmental condition may comprise any state of the environment a monitoring device is configured to operate in or observe. As used in this application, utility consumption may comprise the detected and/or measured environmental conditions.

An environmental condition may comprise the presence, absence, and/or amount of a substance or condition. For example, an environmental condition may comprise the presence, absence, or increase of a hazardous substance or condition. Furthering the example, an environmental condition may comprise the presence of harmful radiation, and the meter device 110 may be configured to detect the presence of the radiation, measure an amount of the radiation, and/or measure or detect if the amount of radiation is unacceptable. As an additional example, an environmental condition may comprise the presence of carbon dioxide (CO₂), and the meter device 110 may be configured to measure the amount of CO₂ present. An environmental condition may comprise the presence, absence, or reduction of a beneficial substance or condition. For example, an environmental condition may comprise a reduction in breathable oxygen (O₂), and the meter devices 110 may be configured to detect if the level of O₂ present can negatively affect humans, or may be configured to measure the amount of O₂ present. An environmental condition may comprise a ratio of substances. For example, the meter device 110 may be configured to measure the ratio of CO₂ to O₂.

In addition, an environmental condition may comprise the presence or absence of a substance caused by other utility consumption. For example, combustion of natural gas consumes O₂ and produces CO₂ and water, and the meter device 110 may be configured to measure O₂, CO₂, and/or water. For further example, the meter device 110 may be configured to only measure the environmental conditions caused by other utility consumption, such as measuring only the O₂, CO₂, and/or water consumed and produced by the combustion of natural gas.

An environmental condition may comprise any other measurable quantity or quality relating to the environment the meter device 110 is configured to operate in or observe. For example, an environmental condition may comprise the temperature, status of air conditioning or heating, air circulation, light level, sound level, and the like. In addition, environmental conditions may not be limited to those relevant to humans or other forms of life, and may comprise conditions affecting machines, equipment, materials, and the like. In addition, the meter device 110 may be configured to measure and/or detect an environmental condition of water, air, earth, and/or space.

In some embodiments, the meter device 110 may comprise an electricity meter, a gas meter, a water meter, a smoke detector, a carbon monoxide detector, or a CO₂ meter. The meter device 110 may collect information about the consumption of only one utility type, such as electricity, or may collect information about the consumption of more than one utility type. The meter devices 110 may each collect information about the same type of utility, or may each collect information about different types of utilities. For example, all meter devices 110 may collect information about electricity usage, or some meter devices 110 may collect information about electricity usage while other meter devices 110 collect information about water usage. Similarly, in some embodiments, the meter device 110 may collect information about one environmental condition, such as CO₂, or may collect information about more than one environmental condition.

The one or more meter devices 110 may be communicatively linked with the EDC module 120, and the EDC module may be configured to receive time series data from the one or more meter devices 110. In some embodiments, the EDC module 120 may be communicatively linked with the analytical database 160, and may be configured to receive time series data from the analytical database 160, such as representing a virtual meter device. The EDC module 120 may comprise a computing unit configured to, and/or software instructions for causing a computing unit to, detect errors in the received time series data and correct any detected errors. For the sake of brevity, a computing unit and/or the software instructions may be referred to as hardware and/or software.

The EDC module 120 may be communicatively linked with a data warehouse 130. The data warehouse 130 may comprise any suitable hardware and/or software configured for long-term storage of time series data. In some embodiments, the data warehouse 130 may comprise a relational database configured to store the type of time series data received from the meter devices 110. The data warehouse 130 may be communicatively linked with a transformation module 140.

The transformation module 140 may be communicatively linked with the configuration definition store 150 and the analytical database 160. The transformation module 140 may comprise any suitable hardware and/or software configured to extract time series data from the data warehouse 130, transform the time series data according to information retrieved from the configuration definition store 150, and load the analytical database with the transformed time series data. The process of extraction, transformation, and loading may be referred to as ETL.

The configuration definition store 150 may comprise any suitable hardware and/or software configured to store, modify, and provide information corresponding to physical meter devices, virtual meter devices, and hierarchies based on any combination of physical and/or virtual meter devices. This information may be referred to as a configuration definition. The analytical database 160 may comprise any suitable hardware and/or software configured to store the transformed time series data. In some embodiments, the configuration definition store 150 may comprise one or more relational databases configure to store Master Data and Meter Data configuration definitions (further described below), and the analytical database 160 may comprise an OLAP database configured according to the Master Data and Meter Data configuration definitions. The Master Data and Meter Data configuration definitions may also be referred to as Master Data and Meter Data, Master Data and Meter Data configurations, and Master Data and Meter Data definitions.

In some embodiments, the analytical database 160 may be communicatively linked with the EDC module 120. Transformed time series data may be communicated from the analytical database 160 to the EDC module 120, where it may be treated as if it were a physical source of time series data and may undergo error detection and correction, just as with a physical meter device, and may be subsequently stored in the data warehouse 130 and transformed into the analytical database 160.

The above description has made reference to one or more databases. A relational database, as a general term, may comprise a computer software application developed to organize and store data in structures formally called tables from which data can be easily accessed. A warehouse database, such as the data warehouse 130 may comprise a database system capable of storing a large amount of information. A warehouse database may comprise an OLTP (Online Transaction Processing) database or any other suitable database type. An analytical database, such as the analytical database 160 described above, may comprise a database system capable of handling multi-dimensional analytical queries, which are more complex than those handled by more traditional relational databases. An example of such an analytical database is an OLAP (Online Analytical Processing) database. An OLAP cube may comprise a multidimensional data structure which contains measures (facts) organized into dimensions within an OLAP database. Each dimension may comprise a hierarchy. The Master Data and Meter Data configuration definitions may describe the dimensions and hierarchies.

The dimension allows for the analysis of data from various perspectives in an OLAP cube. For example, the dimension may comprise a location dimension, which can organize information by country, region, and city, or the dimension may comprise an enterprise dimension, which can organize information by entity, building, system, and meter device. The organization within a dimension may be referred to as a hierarchy. A measure is a numeric representation of a fact that has occurred. For example, the measure may comprise a dollar amount of an annual sales report, a shipping cost, a percentage of a profit target, a reading from a meter device 110 such as energy consumption, energy demand, temperature, flow rate, cost, CO₂, and the like.

The hierarchy defines parent-child relationships among various levels within a single dimension. A level is a column within a dimension table that could be used for aggregating or summarizing data. For example, the dimension may comprise a product dimension which has hierarchy levels of product type (beverage), product category (alcoholic, carbonated), and product class (beer, wine, liquor). In another example, the dimension may comprise a time dimension, in which a hierarchy level of a year is a parent of four quarters, each of which is a parent of three months, which are parents of 28 to 31 days, which are parents of 24 hours. Traditionally, OLAP cubes hierarchies have matching levels of depth. However, various embodiments of the present invention allow for irregular hierarchies comprising branches of variable levels of depth. Further, various embodiments of the present invention allow for changing hierarchies using techniques such as slowly changing dimensions (SCD) combined with the use of effective dates of the changes. Other techniques may be used to accommodate a changing hierarchical structure.

The hierarchy may represent the strict physical world, such as rooms, floors, buildings, and the like, may represent the non-strict physical world and/or business worlds, such as teams, groups, departments, divisions, commercial entities, and the like, or may represent any combination thereof. Such hierarchies may be referred to as representative hierarchies. It will be observed that representative hierarchies may be irregular in that each branch of the hierarchy may have different levels of depth. For example, one branch of a hypothetical representative hierarchy may only have three levels of depth before attaining a leaf node, while its sibling branch may have five levels of depth before attaining a leaf node. In contrast, a normalized (or “regular”) hierarchy requires that every branch conform to a singular depth structure. Further, at a particular level of depth, a hierarchy may comprise both a meter device (physical and/or virtual) and an entity. For example, a hypothetical Region 4 hierarchy may comprise a Campus G hierarchy and a meter device S (e.g. a solar farm connected to the grid may not feed a specific building but it may be desired to track what it produces).

As an example of changing hierarchies, over time, the owner of a facility may decide to add a new building, modify an existing one, rename buildings or rooms, or replace building systems such as replacing an electricity heating system by a solar power system. For further example, a tenant may move into one area of a building that was previously occupied by someone else the prior day. The corresponding meter devices and hierarchies may be modified to belong to the new tenant or owner. This may be accomplished with changes to the Master Data and/or Meter Data configuration definition.

In an embodiment of the present invention, the Meter Data configuration definition may comprise information corresponding to attributes of the physical and virtual meter devices 110 and their relationships. For example, the Meter Data configuration definition may comprise information about a meter device's make and model, computational relationship of the meter devices, hierarchies of meter devices, and the like. As discussed, the virtual meter device 110 may represent a calculation or summary based on one or more physical meter devices 110. For example, the virtual meter device 110 may comprise a collection of physical meter devices 110 divided by the square footage of the space monitored by the meter devices 110, thus creating the virtual meter device 110 that represents a meter device that is normalized for square footage. A hierarchy of meter devices may comprise any mix of physical and/or virtual meter devices 110.

The Master Data configuration definition may comprise information corresponding to attributes such as occupancy, square footage, facility purpose, and the like for a building a meter device 110 is located in, as well as the geo-location of the meter device 110 and other attributes of the geo-location such as street address, corporate address, customer branding information, and the like.

The analytical database 160 may be dynamically loaded and/or configured based on Master Data and/or Meter Data configuration definitions, which may be irregular and may change over time. Consequently, the Master Data and Meter Data configuration definitions may be dynamic. The Master Data and Meter Data configuration definitions may be tightly coupled into levels that equate to dimensions in the analytical database 160. These levels may be configured into a single physical hierarchy and any number of virtual hierarchies required for the on-demand customer analysis. These dimensions may be slowly changing dimensions, which are designed to change over time to reflect the unique needs of the physical and virtual entities and device hierarchies required for today's intelligent facilities. The Master Data and Meter Data configuration definitions may describe these hierarchies.

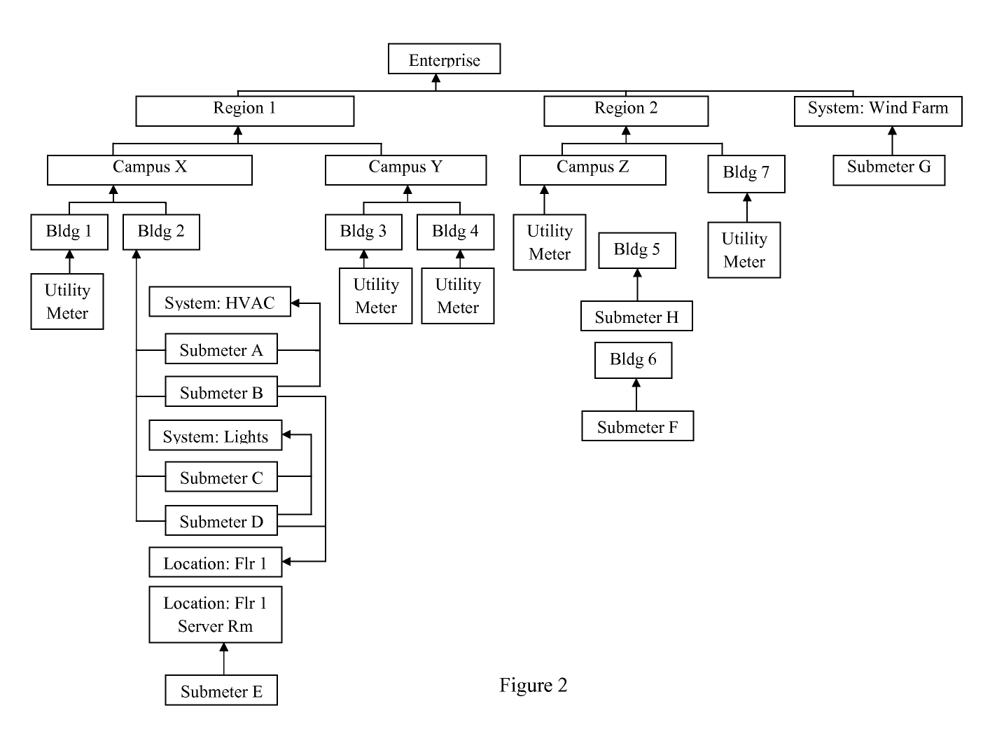

Referring to FIG. 2, an illustration of a hypothetical Enterprise hierarchy is shown. The Enterprise hierarchy may comprise a Region 1, Region 2, and Wind Farm hierarchy. The Region 1 hierarchy comprises a Campus X and Campus Y hierarchy. The Campus X hierarchy comprises a Building 1 and Building 2 hierarchy. The Building 2 hierarchy comprises Submeters A through D. A hierarchy for the HVAC system in Building 2 comprises Submeters A and B, and a hierarchy for the lighting systems comprises Submeters C and D. The hierarchy of Floor 1 comprises Submeters B and D. The hierarchy of the Floor 1 Server Room comprises Submeter E. In this hypothetical, Submeter E may already be covered by Submeteres A through D, and so the Building 2 hierarchy does not comprise Submeter E. Campus Z may only have two buildings, but the hierarchy for Campus Z does not comprise Building 5 and Building 6 because, in this hypothetical, there is a separate load, such as outdoor lights, that are not including in Building 5 or Building 6. Therefore, in this hypothetical, the hierarchy of Campus Z comprises a Utility Meter. In this example, the hierarchy levels (e.g. dimension levels) are comprised of entities, buildings, systems, and devices (e.g. physical or virtual meter devices 110).

Time series data may comprise data points collected from a meter device 110 over specified time periods of ranging from fractions of a second to n number of minutes, hours, days, months, years, and the like. Time series data tends to quickly accumulate to vast amounts of volume. Traditional relational databases can initially handle that volume but are not designed to be scalable with the same degree of performance over a long period of time.

Traditional relational databases are also not designed to retrieve a multidimensional view of the data with the same degree of performance over a long period of time, especially for example when one wants to see time series data for a building summarized into a series of physical and virtual hierarchies (multiple views of the same dataset in near real-time fashion), which requires more aggregation of data. For instance, the manager of a facility that comprises several buildings organized into different levels of depth may want to quickly know the consumption of electricity for the entire facility in 5 minute intervals for a specific range of time; the amount of time series data collected, overall for the entire facility may be manageable for a short period of time but can grow exponentially when summarized (or aggregated) calculations (such as for representative hierarchies and virtual devices) are also stored in the relational database.

In order to handle this growth in volume and quickly provide information corresponding to any hierarchy level, the information or data may be summarized into an analytically-optimized database, such as an online analytical processing store (also referred to as an OLAP database). As discussed above, an OLAP database comprises an aggregation of facts for various hierarchy levels of the various dimensions of an OLAP schema. The aggregation may be referred to as an OLAP Cube. In various embodiments of the present invention, the organization within the OLAP database may be based on the Master Data and Meter Data configuration definitions. In other words, the Master Data and Meter Data configuration definitions may provide the dimensions and hierarchies used to organize the OLAP database.

Real Time Analytics and Reporting (sometimes referred to as Real Time Analytics and Visualization), the process of exposing the data as a complete data set, may not be possible without the ability to intelligently fill in gaps and correct anomalies in the time series data, while loading and summarizing the incoming information in the desired format in a period of time deemed acceptable, such as in real-time which may be measured from the receipt of a time series data point from a meter device 110 and on the order of fractions of a second to minutes.

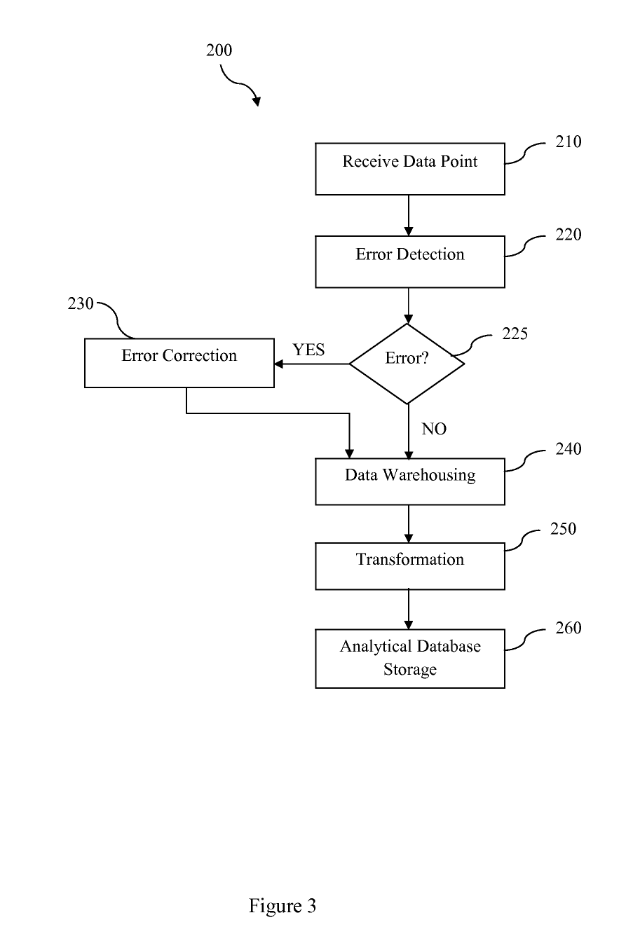

Referring now to FIG. 3, an error detection and correction method according to various aspects of the present invention may comprise receiving time series data (210), performing error detection (220) on the received data, performing error correction (230) on the received data if an error is detected (225), storing the time series data in a data warehouse (240), transforming the time series data stored in the data warehouse (250), and storing the transformed time series data to an analytical database (260). Receiving time series data (210) may comprise any system and/or method for receiving one or more time series data points, such as time series data corresponding to a physical meter device or a virtual meter device. Time series data corresponding to virtual meter device may originate from a query made to the analytical database 160. Time series data may also comprise time series data entered manually.

In order for the received time series data to be analyzed and summarized accurately the data needs to be proactively corrected for gaps and anomalies that occur in the data points from the actual meter devices that exist in the buildings or other facilities. The time series data is incomplete if the gaps and anomalies are not corrected before the data is loaded into long-term record storage.

Error detection (220) may comprise identifying gaps and anomalies in the received time series data. Error correction (230) may comprise a method of applying heuristic algorithms, such as regression analysis, to historical time series data to replace gaps and anomalies with estimated values. A set of time series data may be considered complete when no gaps are detected. A set of time series data may be considered cleansed when no errors are detected after undergoing gap analysis, threshold detection, and error correction processes as deemed necessary.

In an embodiment, the heuristic algorithms employed during error correction (230) can be applied to a range of time series data to generate a projected model of time series data representing possible alternative outcomes in the past or in the future based on additional normalization factors such as system-calculated measures, measures calculated outside of the system but submitted into the system by the same data collection methods employed in the system for energy time series data, numerical parameters submitted in a generalized query for an energy meter data reporting system, and the like. In yet another embodiment, the data projection models can become the basis for additional error detection algorithms whereby time series data for a device may not fall within the designated thresholds of the data projections, otherwise known as an energy performance target, and can initiate an alert for non-conformance to an agreed upon project model.

A gap in time series data occurs when the data point representing an expected time interval is absent. Error detection (220) may comprise the identification of a gap, such as the identification of one or more sequential absences of data points. The absence of the data point can be caused by the inaccessibility of the data source or the unavailability of the data point at the time of data collection. For example, an electricity meter that is configured to expose or report a data point every 5 minutes may fail to expose or report a value. The detection of gaps in time series data, referred to as gap analysis or gap detection, may comprise the application of heuristic algorithms that identify gaps in times series data.

In one implementation, the detected gaps in time series data may be filled through the execution of data modeling methods. This may be referred to as data forecasting. Data forecasting may comprise the use of historical time series data as the basis of estimating the missing time series data points. Data forecasting may comprise calculating any number or combination of moving averages, weighted moving averages, extrapolations, interpolations, linear predictions, regression analyses, trend estimations, and the like. The historical time series data may reside in any suitable location. In an exemplary embodiment, the historical time series data may comprise the recent raw data received from one or more meter devices 110 (such as the meter device having a gap in time series data), may reside in the data warehouse 130, and/or may reside in the analytical database 160. Data forecasting may comprise the use of external influencing factors, such as weather, location, schedules, and any other external factor that may influence a meter reading.

Error correction (230) may comprise correcting a gap by estimating the one or more time series data points that are absent. In one embodiment, the detected gaps in time series data may be filled through simple linear regression models. Additional methods and models of implementation include: averaging previous years of cleansed historical time series data for the missing time internals; modeling against previous years based on the normalized time series trend for the current year; modeling against normalized time series trends for similar buildings in comparable weather climates or occupancy rates for the missing time intervals; modeling from public or private normalized time series trends representing typical building consumption rates; any combination of the above or of similar time series models; and similar heuristic algorithms.

For example, a utility meter which is defined to send electricity data every 5 minutes stops sending data at 10:00 AM and restarts to send it at 10:30 AM. In this case, there are 5 electricity data readings missing for the meter at: 10:05 AM, 10:10 AM, 10:15 AM, 10:20 AM, 10:25 AM. Error correction (230) may correct the gaps by applying a regression analysis formula based on the last and next utility meter readings. In the above example, error correction (230) may comprise the use the electricity reading at 10:00 AM and 10:30 AM to correct the 5 missing readings.

An anomaly in time series data occurs when the time series data point representing an expected time interval is not within the range of values expected. Error detection (220) may comprise the identification of one or more time series data points is not within the expected range of values. The expected range may be determined by manually defined upper and lower thresholds or by algorithmically generated upper and lower thresholds based on historical time series data or by algorithmically generated upper and lower thresholds based on historical time series data combined with gap analysis considerations. The detection of anomalies in time series data, referred to as threshold detection or anomaly detection, may comprise the application of heuristic algorithms that identify anomalies in time series data. Error correction (230) may comprise correcting an anomaly by estimating the correct value of the one or more time series data points that are anomalous.

Many types of anomalies may be detected in real time. Anomalies may be detected by using thresholds, which may define the acceptable range for a meter device reading, and may be static or dynamically computed. Thresholds may define an acceptable range for deviation from expected behavior, and may be static or dynamically computed. Any number or type of thresholds may be used.

In one embodiment, dynamically computed deviations may be defined through execution of data modeling algorithms (e.g. data forecasting) similar to those used to fill detected gaps in time series data. In another embodiment, combinations of different types of threshold rules may be used as to allow a flexible range of permissible time series record values for any particular level in the hierarchy of devices. The root cause for anomaly detection may include, but is not limited to, the reconfiguration or wholesale replacement of the associated physical meter device.

To further illustrate error detection (220) and error correction (230), several detailed examples are now presented. For example, a gap from a meter device may comprise one or more sequential absences of values. The gap is “open-ended” when there is only 1 bookend of actual values (e.g. the outage is still ongoing), otherwise the gap is “enclosed” when there are 2 bookends of actual values (e.g. the period of time an outage was active and data was thus lost). The raw data from a meter device may be akin to an odometer reading in that it is an always-increasing value. For example, an electricity meter may continuously increment the amount of electricity used and report this value. The long-term storage, such as data warehouse 130, may preserve the original raw data, extrapolated readings, and interpolated consumption rates. The extrapolated readings are those which have taken meter device resets into consideration. For example, if the meter device resets to 0 every Sunday, the long-term storage would preserve the artificially incremented value (the extrapolated reading) in addition to the raw value. The long term storage would also preserve the consumption rate for that specific moment in time. The analytical database 160 may preserve the pre-computed consumption rates as aggregated by various hierarchies.

If, for example, the reading for a hypothetical Smart Meter A at 2:45 pm is missing, then the error detection and/or correction systems and methods (the EDC module 120, error detection (220), and/or error correction (230)) may preemptively save the missing data point's place in the database and add a conditional flag, representing the fact that the data point is late or missing, prior to performing data forecasting to attempt to fill in the gap. A suitable window of opportunity may be provided for the data point to arrive (e.g. 2 minutes, or at 2:47 pm). After the window of opportunity has expired and the data point has not been received, data forecasting may be performed to see what the last few raw readings were for Smart Meter A to determine an estimated trend. If a user only desires that level of correction, this basic forecast estimate is preserved and flagged as an estimate. If the user desires a more accurate correction, then the data forecasting may be performed on the extrapolated readings.

If the user desires even more accuracy, then the data forecasting may take the forecast based on the raw data, then the extrapolated long-term values, and create a differential between these two estimates. The blended average estimate is then used to supply the missing data point. This level of accuracy may have several algorithms to choose from, such as: moving averages for any number of periods such as 5-day, 7-day, 30-day, 6-mo, 12-mo, and the like. The raw data may only be considered as far back as its last reset, such as when the raw data for a rolling-total (always incrementing) meter value is suddenly lower than its previous meter values. In addition, weather normalization equations may also be used. For example, if the date range used for the computation is greater than 30 days and there is a year's worth of historical usage data available, then weather normalization equations may be used to help influence and estimate the possible value.

If an even higher level of accuracy is desired, then the data forecasting may comprise the previous computations but also take pre-defined baselines into consideration when computing the blended average estimate. A pre-defined baseline may comprise other aggregations from similar or different data sources (e.g. meter devices) for the same hierarchy that are categorized as hypothetical usage patterns.

An even higher level of accuracy may be obtained by employing the above forecasting methods in addition to reading aggregations stored in the analytical database 160, such as aggregations computed by the OLAP cube. Additional data sources external to the meter devices 110 may also be considered (e.g., external influencing factors), such as occupancy changes (itself estimate-able, itself a branch within the same or alternate hierarchy, or simply a slow changing dimension), adjustments to square footage (another SCD but can be used as part of a complex equation to determine the energy consumption as attributed on an unit of surface area basis), calendar of operations (Master Data configuration definition used as part of a complex equation to determine the consumption trends on a time-of-day/day-of-week basis), weather conditions (real-time weather comparisons), in addition to other external factors such as historical utilities spending, days per month, typical usage patterns based on meter device and facility type, other building information modeling (“BIM”) algorithms, geo-location and usage pattern trends within similar weather climate zones, usage patterns adjustments as influenced by real-world news events, construction schedules, airport traffic patterns, and the like.

The data forecasting methods described above may be used to fill in an enclosed gap or an open-ended gap. The known post-gap value for an enclosed gap may be taken into consideration as an upper limit. The trend after the gap may be taken into consideration when estimating both a singular and a multiple sequentially-absent values, and taking the first value after the gap into consideration as the upper limit of any values used to fill in the gap.

The data forecasting methods described above allow a gap in time series data to be filled in with an estimated value. The estimated value may be replaced when the actual value is determined.

As another example, for anomaly detection, the upper-bound and lower-bound thresholds may be set by using the same mix of data forecasting described above, although modified for upper/lower-bound situations. For example, when trying to fill in a gap, averages may be taken because only one value is desired for that moment in time. For threshold detection, an upper threshold may be determined by taking the maximum value of every reasonable interval (e.g., the largest single “actual” (non-auto-corrected) value received within every hour) to create an upper-bounds trend. Similarly, a lower threshold may be determined by taking the minimum value of every reasonable interval to create a lower-bounds trend. Regression analysis may be based against these data sets, as opposed to every actual value or the blended average of actual values, to generate the upper and lower thresholds of an allowable range. The data forecasting for thresholds may be augmented by using additional factors (such as weather, season, time of day) and Master Data configuration definition (such as occupancy, square footage, designated facility purpose) to influence the allowable range. Similar to how several data forecasting methods and formulas may be blended together to fill in gaps in time series data, such computations can also occur when determining the probability that a threshold limit is in fact the consensus limit based on different models.

Once the thresholds are established, the received time series data point is evaluated. If the received data point fits, then it may be added to long-term storage, such as the data warehouse 160. If the received data point does not fit within the established thresholds, then an analysis may be performed to determine whether the data point is in fact unacceptable and/or erroneous, whether the data point represents a real change in pattern, or whether the data point represents the aggregate of the preceding gaps as a new corrective value. This analysis may be performed by the EDC module 120 and/or during error detection (220) and/or error correction (230).

For example, if the preceding values were detected as gaps, and the current data point exceeds the permissible thresholds, then an attempt may be made to divide the current data point value into the detected gaps plus the current received data point (since the current time period requires a value as well) and every suggestive gap-fill is individually re-evaluated for correctness within the established thresholds. For example, given four expected time series data points, where the first data point is “6”, the second and third data points are missing, and the fourth data point is “24,” at attempt may be made to determine if the fourth data point is the aggregate of the missing data points and the fourth data point, and it may be divided across the corresponding time slots (e.g. 24 divided by 3=6 for each time slot), resulting in an estimated value of “6” for the second, third, and fourth data point.

The division across preceding gaps may be simple (e.g. linear distribution) or may be calculated based on the sample distribution's variance with the typical thresholds for the Meter and Master Data configuration definitions. For example, if the time period is usually low-usage but the sample distribution results in a high-usage value, then the calculated distribution would try to establish the average between upper and lower thresholds and then only allocate the established average value from the original corrective value dump. This allows the corrective value dump to be properly distributed among the gaps as to properly represent what probably happened at every time interval. If the new values are all acceptable, then the new values may replace previously-suggested values with the new values and those records may be flagged as having been corrected by way of an automated corrective batch. If the new values are not all acceptable, then the EDC module 120, the error detection (220), and/or the error correction (230) steps may assume that the current data point is not a new corrective value dump.

Continuing the example, if there was no preceding gap, the EDC module 120, the error detection (220), and/or the error correction (230) steps may attempt to consider the current data point as a real value, which may modify the usage pattern of the meter device 110 the current data point corresponds to. This attempt is made by evaluating certain factors, such as whether the current data point is within a reasonable fixed or statistical range beyond the threshold boundaries (e.g., definable by the customer or organization), whether there was a recent change to the meter device's representative Meter Data configuration definition (such as the amount of square footage or occupancy that its usage should be associated with), and whether there are indicators in the Master Data configuration definition that suggest piercing the thresholds is acceptable (such as scheduled high-/low-occupancy incidents on/near the physical premises, scheduled downtime associated with renovation/construction projects on/near the physical premises, weather events affecting on/near the physical premises due to previously-communicated weather forecasts, and the like). If the current data point is acceptable, then the EDC module 120, the error detection (220), and/or the error correction (230) steps may keep the current data point (such as storing it in long-term storage) and the current data point may influence subsequent threshold calculations and data forecasting. If the current data point is not acceptable, then the EDC module 120, the error detection (220), and/or the error correction (230) steps may assume that the current data point is erroneous and the current data point may be so flagged.

Continuing the example, if the current data point is to be flagged as unacceptable, then appropriate notification triggers may be initiated, the timestamp may be flagged as having an unacceptable meter reading, and the current data point may be excluded from calculations. In some cases, if the meter device 110 has been previously identified as problematic, the meter device 110 may be exempt (or actively suppressed) from alert notifications and alarm protocols. If the current data point is unacceptable, then the current data point may be treated as a gap and the gap-filling data forecasting described above may be utilized to estimate a correct value of the current data point. When the actual correct value of the current data point is provided (e.g. by manual data entry or by delayed receipt of the value), then additional heuristics may be conducted against the correct value. For example, if the manually supplied correct value is beyond the established thresholds, a warning may be generated to the end-user that the manually-supplied correct value may not fit within the statistical range as the systems and methods would have computed it.

The system 100 and method 200 may also be proactive as the system 100 and method 200 may be judicious when qualifying an incoming piece of data as acceptable for preservation, and thus more reputable for any further calculations. The system 100 and method 200 facilitates the qualification of in-bound meter device time series data before relying on the in-bound meter device time series data for calculations and analysis. In addition, the detected gaps may also be flagged for reanalysis at a later date in order to reapply the same or a different error detection (220) and error correction (230) methods (such as using the EDC module 120) based on a larger collection of actual time series data, before and/or after transformation, for the designated building, meter device, utility, and the like.

To summarize, error detection and error correction methods traditionally are applied to time series data after the time series data has already been stored in a long term data storage warehouse. In an embodiment of the present invention, the error detection and correction methods are applied in a real time fashion as the time series data may be initially attributed to specific meter devices in a building hierarchy and evaluated for correctness before committing the readings for long term record storage. In this embodiment, the cleansed time series data assures greater accuracy and improved perceived computer system performance when reporting or analyzing the most recent time series data readings without having to conduct computationally expensive on-demand calculations when a report or visual representation is desired.

Once the received time series data undergoes error detection (220) and possibly (225) error correction (230), the received time series data may be stored in the data warehouse 130 (240). Storing the time series data in the data warehouse 130 (240) may comprise moving the time series data into predefined relational database tables. Ensuring and storing accurate and complete time series data is a part of the process. In addition, the analytical database 160 may be dynamically loaded and/or configured based on possibly irregular and changing Master Data and/or Meter Data configuration definitions. In some embodiments, the Master Data and Meter Data configuration definitions represent one or more hierarchies of meter points that may be created by a module of this invention. The hierarchies may organize the physical and/or virtual meter devices of one or more facilities into different levels at which the time series data can be aggregated or summarized according to the Master Data and/or Meter Data configuration definitions.

The configuration of the Master Data and Meter Data configuration definitions may be performed manually, such as in a point-and-click manner. The configuration may also be accomplished by the execution of database scripts, by the automatic processing of specifically-formatted configuration files, and the like. Once an initial Master Data and/or Meter Data configuration definition is available, all subsequent alterations or derivative configurations may be accomplished by the same methods, or by configuring a “trigger” to duplicate a configuration but with the intended modifications. Such triggers may be derived from business rules within or outside of the systems and methods of the present invention. For example, the systems and methods of the present invention may be configured to consume values submitted through or retrieved from external computer networks.

In some embodiments, Master Data and Meter Data configuration definitions may be entered by a business customer or authorized party into a secure Web site or installable software program designed to capture such information. In one embodiment, the authorized agent may supply the commonly referenced name, operational organization unit, organizational categories, representative energy industry utility, sampling rate for a specific building belonging to a business customer's facility, and the like. The characteristics captured in the Master Data and Meter Data configuration definitions are grouped in a manner consistent with the dimensions made available in the analytical database 160, such as an OLAP database.

The time series data may be retrieved from the data warehouse 130 and may be transformed (250) into a format suitable for analysis. In some embodiments, transformation (250) of the time series data may comprise using standard extraction, transformation, and loading (“ETL”) procedures and tools, in combination with the Master Data and/or Meter Data configuration definitions, to transform the time series data into various dimensions and hierarchies that may be used to load or update an analytical database 160 (260), such as an OLAP database. In some embodiments, an OLAP Cube may dynamically summarize the time series data based on the structure of a building hierarchy, its utilities, its meter devices, its metering plan, and the like. For example, transformation (250) may be responsible for transforming all of the relevant data stored in the data warehouse into the multi-dimensional OLAP Cubes and retrievable by MDX data querying language for use by other processes within this present invention.

For example, time series data may be collected from several physical meter devices 110, and the transformation step (250) may subject the time series data to complex mathematical computations in order to obtain a single time series data set representative of a singular level of a hierarchy. For example, transforming data into a hypothetical hierarchy may comprise deducting time series data from Device A from the simple multiplication of Device B with Device C multiplied by a conversion factor to account for the different magnitudes of their configured units, as represented in Master Data and Meter Data configuration definitions, followed by the division of the surface area of the level associated with Devices A, B, and C, as represented in Master Data and Meter Data configuration definitions.

The Master Data or Meter Data configuration definitions may have an unlimited number of levels whose dimensions in an OLAP Cube may be dynamically configured based on possibly irregular (e.g. a hierarchy's branches may have variable levels of depth) and changing meter point and facility configurations. The irregular and changing hierarchies of meter points and facilities (represented by Master Data and Meter Data) may be represented and recorded in the analytical database 160 using slowly changing dimensions and effective dates or any other suitable method.

Once the analytical database 160 has been loaded, a query may be made to the analytical database 160 to retrieve a transformed and aggregated time series data, for example representing an alternate or virtual meter device or hierarchy configuration. The retrieved time series data may then be fed to the EDC 120 and/or to the receive data point (210) or error detection (220) step as if it were raw data, so that a virtual device or hierarchy may be treated as a physical meter device 110 in an alternate hierarchy. When an alternate hierarchy is configured, the alternate hierarchy needs a data source (raw data) and the raw data may comprise the output from the virtual device. From the perspective of the alternate hierarchy, it may treat the lowest-level of the hierarchy as being comprised of physical devices. The virtual meter device time series data may then proceed through EDC and may become a new baseline time series data. Consequently, time series data going through EDC may have already been through EDC previously.

For example, a hypothetical Customer University has student facilities comprising three gyms and two activity centers, each one with a variable number of floors, rooms, etc. The primary hierarchy for Customer University may comprise a roll-up level called “Student Facilities” which is stored in an analytical database (such as in a OLAP cube) as a virtual device. An extraction (or query) may be performed on this aggregation over the past five years. A hypothetical Typical College is an alternate hierarchy consisting of one gym and one activity center. The output from a normalized Student Facilities query (e.g. based on square footage) is then imported as though it were the “real” physical meter devices 110 representing one gym and one activity center. This loop is accomplished by regularly querying (such as by using MultiDimensional eXpressions language, or MDX) the Customer University OLAP cube at the desired interval that the Typical College meter devices 110 expect as to simulate the intervals of values. The imported query output, which happens to come from virtual devices (the normalized gym and activity center), is perceived as actual meter devices from the perspective of the Typical College hierarchy. The imported query output may then undergo error detection and correction as if the imported query output were an actual meter device 110, and may be stored in the data warehouse 130 and ultimately transformed and loaded to the analytical database 160. The imported query output therefore becomes a new baseline time series data, belonging to an alternate hierarchy than the primary hierarchy.

As previously described, the hierarchy definitions may be created with human intervention and may be stored in relational databases, such as Master Data and Meter Data configuration definitions stored in an exemplary configuration definition store 150. Typical College and Customer University may have a different set of gap and threshold configurations and requirements. For example, Customer University may accept anything within a power factor of three over a four-month average in its thresholds while Typical College may be more stringent and require fluctuations to be within 5% increase/decrease over a 12-month moving average.

Systems and methods according to various embodiments of the present invention may comprise hardware and/or software configured to report or graphically represent time series data. Systems and methods of the present invention may also generate notifications, such as alerts, that an error has been detected and/or corrected. When gaps or anomaly thresholds are attained, a separate module may be responsible for processing business rules governing who gets notified, what information will be sent in the notification, and how the alert notification is communicated. In one implementation, the facility manager receives a daily summary report via email of detected outages and methods used to redress the errors. In another implementation, a designated energy controls engineer can review a report of individual gaps detected, thresholds reached, and devices affected as they log into a Web site designed specifically for customers and authorized parties to review the health of the device network across every level of the meter devices and building hierarchies.

Depending on the security clearances granted on the Web site, the designated energy controls engineer may make adjustments to the meter devices 110 and hierarchies by reporting the replacement of physical devices, the modification of building configurations, or other activities made available for improved meter device data management purposes. These activities may cause the Master Data and Meter Data configuration definitions to be changed to reflect the new hierarchy.

Two components of the systems and methods described above are the collection and dynamic processing of a possibly incomplete and incorrect set of meter device 110 time series data into a complete and sufficiently correct set of time series data; and the dynamic loading of time series data into an analytical database 160, such as an OLAP cube of a possibly irregular and changing hierarchy.

When the accurate and complete time series data is coupled with the dynamic loading into an analytical database of time series data based on a possibly irregular and changing meter device hierarchy, real-time or near real-time analytics and visualization of the time series data is possible. The combination of error detection and correction of time series data prior to long-term storage with the transformation of the time series data based on dynamic configuration definitions creates the an end to end processing of time series data into an analytical database that can be configured for an irregular and changing meter device 110 hierarchy. This combination, for example, allows for the correction and transformation of time series data into virtually any representative hierarchy based on one or more facility's changing and irregular meter hierarchies, such as due to uncoordinated improvements implemented in facilities throughout the world.

For example, a building hierarchy may represent resource consumption for the entire building, and may comprise several meter devices 110. Gap analysis and anomaly detection may be performed on the time series data received from the several meter devices 110. Data forecasting may be used to fill in any gaps or anomalous values in the received time series data, and the (possibly corrected) time series data for each of the several meter devices may be aggregated into a single time series data set representing the resource consumption value for the building. In another example, time series data representing solar power generated by a single solar panel array over a period of time may be deducted from an electricity consumption time series data set for the same time period to dynamically produce a third time series data set which represents a net consumption value.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps in a chemical or biochemical process between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any system embodiment may be combined in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

The present invention has been described above with reference to a preferred embodiment. However, changes and modifications may be made to the preferred embodiment without departing from the scope of the present invention. These and other changes or modifications are intended to be included within the scope of the present invention.

1. A computer-implemented method for evaluating a time series data point from a meter device, comprising:
receiving a time series data point corresponding to a meter reading;
performing an error detection analysis on the time series data point;
performing an error correction procedure on the time series data point in response to an error found by the error detection analysis;
storing the time series data point in a warehouse database;
retrieving the time series data point from the warehouse database;
transforming the time series data point according to a configuration definition; and
storing the transformed time series data point in an analytical database.

2. A computer-implemented method according to claim 1, wherein the error detection analysis comprises at least one of gap detection and anomaly detection.

3. A computer-implemented method according to claim 2, wherein the anomaly detection comprises a regression analysis.

4. A computer-implemented method according to claim 1, wherein the error correction procedure comprises estimating an actual value of the time series data point based on at least one of a raw time series data point, a time series data point in the warehouse database, and a time series data point in the analytical database.

5. A computer-implemented method according to claim 4, wherein estimating the actual value of the time series data point is based on an external influencing factor.

6. A computer-implemented method according to claim 1, wherein the time series data point corresponding to a meter reading is received from the analytical database.

7. The computer-implemented method of claim 1, wherein the analytical database comprises an online analytical processing database.

8. The computer-implemented method of claim 1, wherein the configuration definition describes an irregular hierarchy of meter devices.

9. A non-transitory computer-readable medium storing computer-executable instructions for evaluating a time series data point from a meter device, wherein the instructions are configured to cause a computer to:
receive a time series data point corresponding to a meter reading;
perform an error detection analysis on the time series data point;
perform an error correction procedure on the time series data point in response to an error found by the error detection analysis;
store the time series data point in a warehouse database;
retrieve the time series data point from the warehouse database;
transform the time series data point according to a configuration definition; and
store the transformed time series data point in an analytical database.

10. A non-transitory computer-readable medium storing computer-executable instructions according to claim 9, wherein the error detection analysis comprises at least one of gap detection and anomaly detection.

11. A non-transitory computer-readable medium storing computer-executable instructions according to claim 10, wherein the anomaly detection comprises a regression analysis.

12. A non-transitory computer-readable medium storing computer-executable instructions according to claim 9, wherein the error correction procedure comprises estimating an actual value of the time series data point based on at least one of a raw time series data point, a time series data point in the warehouse database, and a time series data point in the analytical database.

13. A non-transitory computer-readable medium storing computer-executable instructions according to claim 12, wherein estimating the actual value of the time series data point is based on an external influencing factor.

14. A non-transitory computer-readable medium storing computer-executable instructions according to claim 9, wherein the time series data point corresponding to a meter reading is received from the analytical database.

15. A non-transitory computer-readable medium storing computer-executable instructions according to claim 9, wherein the analytical database comprises an online analytical processing database.

16. A non-transitory computer-readable medium storing computer-executable instructions according to claim 9, wherein the configuration definition describes an irregular hierarchy of meter devices.

17. A time series data error detection, correction, and transformation system, comprising:
an error detection and correction module configured to:
receive a time series data point corresponding to a meter reading;
perform an error detection analysis on the time series data point; and
perform an error correction procedure on the time series data point in response to an error found by the error detection analysis;
a data warehouse communicatively linked with the error detection and correction module and configured to store the time series data point;
a configuration definition store configured to store a configuration definition;
a transformation module communicatively linked with the data warehouse module and the configuration definition store, and configured to:
retrieve a configuration definition from the configuration definition store;
retrieve the time series data point from the data warehouse; and
transform the time series data point according to the configuration definition; and
an analytical database communicatively linked with the transformation module and the error detection and correction module, and configured to store the transformed time series data point.

18. A system according to claim 17, wherein the error detection analysis comprises at least one of gap detection and anomaly detection.

19. A system according to claim 17, wherein the error correction procedure comprises estimating the actual value of the time series data point based on at least one of a raw time series data point, a time series data point in the warehouse database, and a time series data point in the analytical database.

20. A system according to claim 17, wherein the configuration definition describes an irregular hierarchy of meter devices.
